(19) United States
(12) Patent Application Publication
(10) Pub. No.: US 2015/0042888 A1
(43) Pub. Date: Feb. 12, 2015

(54) SWITCH APPARATUS AND ELECTRONIC DEVICE

(71) Applicant: HON HAI PRECISION INDUSTRY CO., LTD., New Taipei (TW)

(72) Inventor: CHING-CHUNG LIN, New Taipei (TW)

(21) Appl. No.: 14/450,449

(22) Filed: Aug. 4, 2014

(30) Foreign Application Priority Data
Aug. 8, 2013 (CN) 2013103432799

(51) Int. Cl. H04N 5/268

(52) U.S. Cl. CPC H04N 5/268
USPC 348/706

(57) ABSTRACT

An electronic device connected to numerous loads. The electronic device comprises a number of internal components, including a processor, and a first switch module. The processor is capable of switching between a first working mode and a second working mode. Under the second working mode, the processor generates a second control signal, the first switch mode establishes electronic connections between a specified load and all of the internal components, thus, the specified load simultaneously connects and communicates with all of the internal components.

### CROSS-REFERENCE TO RELATED APPLICATIONS

This application claims priority to Chinese Patent Application No. 201310343279.9 filed on Aug. 8, 2013 in the China Intellectual Property Office, the contents of which are incorporated by reference herein.

### FIELD

The present disclosure relates to a switch apparatus.

### BACKGROUND

Television only accesses an external device for displaying images and videos stored in the external device. The communication between the television and the external device is one way.

### BRIEF DESCRIPTION OF THE FIGURES

Implementations of the present technology will now be described, by way of example only, with reference to the attached figures.

FIG. 1 is a block diagram of an embodiment of an electronic device connected to a plurality of loads, the electronic device comprising a processor, a first switch module, and a second switch module.

FIG. 2 is a block diagram of an embodiment of the first switch module of FIG. 1 the electronic device of FIG. 1.

FIG. 3 is a partial block diagram of an embodiment of the processor and the second switch module of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

The present disclosure is described in relation to an electronic device with a plurality of internal components which can simultaneously communicate with a connected load beside the electronic device.

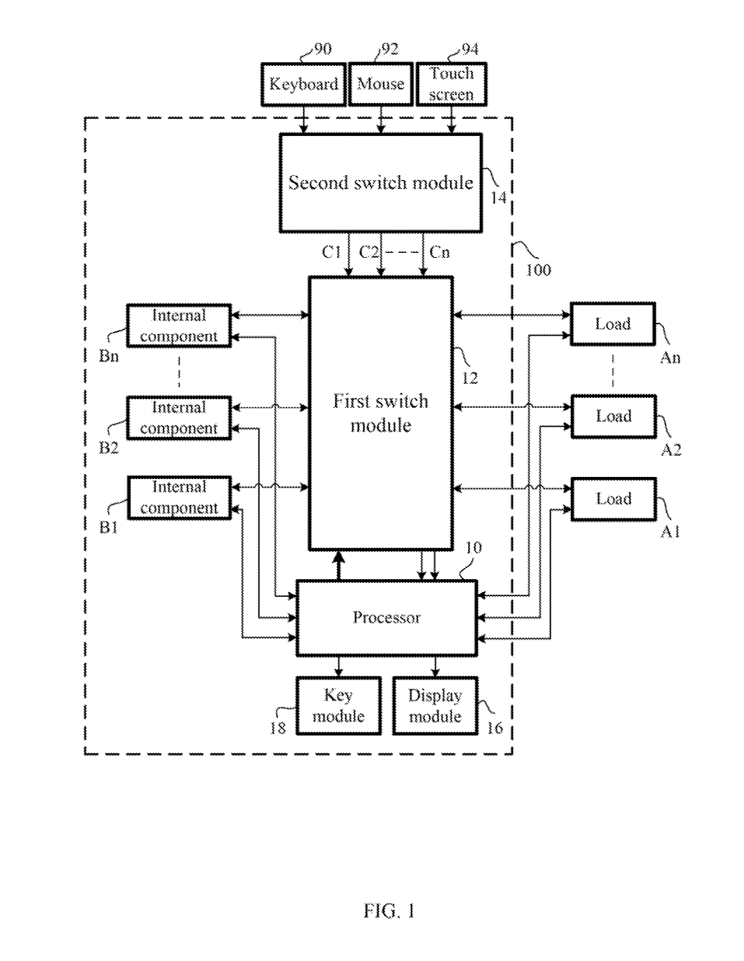

FIG. 1 illustrates an embodiment of an electronic device 100 coupled to a plurality of loads A1-An. In at least one embodiment, the electronic device 100 connects wirelessly with the loads A1-An. In other embodiments, the electronic device 100 connects via a wire with the loads A1-An.

The electronic device 100 can include a processor 10, a first switch module 12, a second switch module 14, a display module 16, a key module 18, a plurality of internal components B1-Bn, a keyboard 90, a mouse, and a touch screen 94. In at least one embodiment, the internal component can be a hard disk, a CD driver, a loudspeaker, or a universal serial bus (USB) printer.

The processor 10 connects between the loads A1-An and the internal components B1-Bn. The processor 10 is capable of switching between a first working mode and a second working mode. The processor 10 obtains operation interface information related to the loads A1-An and the internal components B1-Bn to be displayed on the display module 16. In at least one embodiment, a predetermined key (not shown) of the key module 18 is pressed to switch between the first working mode and the second working mode. Under the first working mode, by lifting one of the user loads A1-An and one of the internal components B1-Bn, the processor 10 generates a first control signal. Under the second working mode, once one of the loads A1-An is lifted and one of the internal components B1-Bn is lifted, the processor 10 generates a second control signal.

The first switch module 12 connects between the loads A1-An and the internal components B1-Bn. The first switch module 12 turns on to establish an electrical connection between the selected load and the selected internal component in response to the first control signal. Thus, the selected load and the selected internal component are in communication with each other. The first switch module 12 turns on to establish electrical connections between the selected load and each of the internal components B1-Bn respectively in response to the second control signal. Thus, the selected load simultaneously communicates with each of the internal components B1-Bn. In at least one embodiment, the communication is a bi-directional data transfer.

The first switch module 12 further generates a first locking signal and a second locking signal while a read/write operation occurs between the selected load and the connected internal component(s). The processor 10 further controls the first switch module 12 to be a locked state in response to the first locking signal and the second locking signal for preventing interruption to the read/write operation.

The first switch module 12 further generates a first unlocking signal and a second unlocking signal while the read/write operation is finished. The processor 10 further controls the first switch module 12 to be cut off in response to the first unlocking signal and the second unlocking signal for cutting off the connection(s) between the selected load and the connected internal component(s).

The first switch module 12 further simultaneously connects with a keyboard 90, a mouse 92, and a touch screen 94 via the second switch module 14.

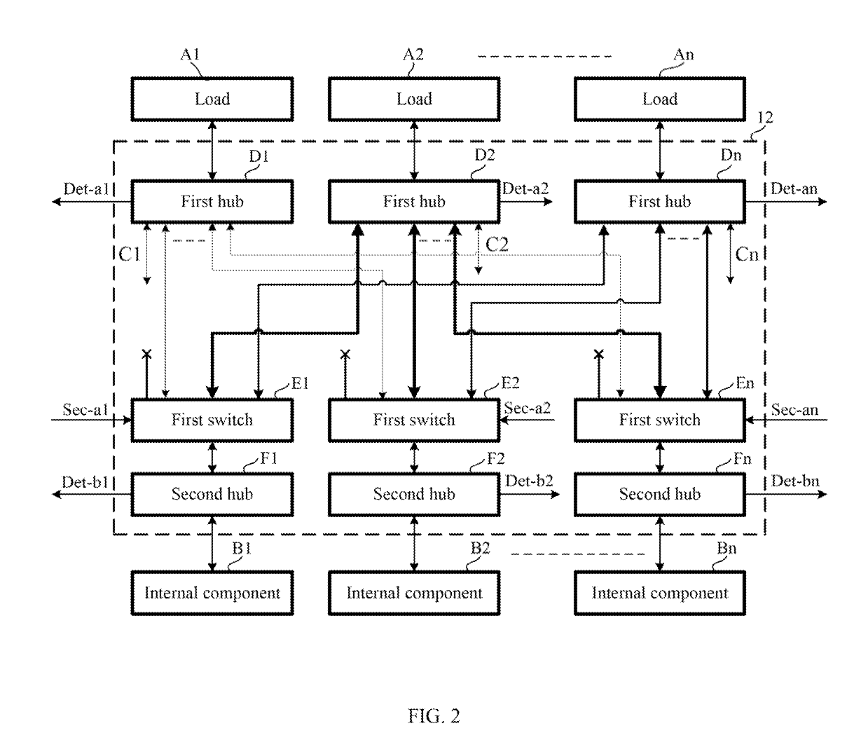

FIG. 2 illustrates that the first switch module 12 can include a plurality of first hubs D1-Dn, a plurality of first switches E1-En, and a plurality of second hubs F1-Fn. In at least one embodiment, the first hubs D1-Dn and the second hubs F1-Fn can be Universal Serial Bus (USB) or External Serial Advanced Technology Attachment (eSATA) type hubs.

Each of the first hubs D1-Dn includes a first input terminal, a plurality of first output terminals, and a plurality of connected terminals C1-Cn. The first input terminals of the first hubs D1-Dn electrically connect to the loads A1-An in a one-to-one relationship. Each of the first hubs D1-Dn simultaneously connects with the first switches E1-En through the first output terminals. The terminals C1-Cn electronically connect to the second switch module 14.

Each of the first switches E1-En can include a first switching terminal, a plurality of first fixed terminals, and a second fixed terminal. Each of the first switches E1-En simultaneously connects with the second hubs F1-Fn through the first switching terminals. Each of the first switches E1-En simultaneously connects with the first hubs D1-Dn through the first fixed terminals. The first switching terminal is capable of electrically connecting to one of the corresponding first fixed terminals for turning on the corresponding first switch, and is capable of electronically connecting to the corresponding second fixed terminal for turning off the corresponding first switch.

Each of the second hubs F1-Fn can include a second input terminal and a plurality of second output terminals. The second input terminals of the second hubs F1-Fn electrically connect to the internal components B1-Bn in a one-to-one relationship. The second output terminals of the second hubs F1-Fn electrically connect to the first switching terminals of the first switches E1-En in a one-to-one relationship.

Each of the first hubs D1-Dn generates the first locking signal while the corresponding user load is in a read/write operation, and generates the first unlocking signal while the read/write operation is finished. Each of the second hubs F1-Fn generates the second locking signal while the corresponding internal component is in a read/write operation, and generates the second unlocking signal while the read/write operation is finished.

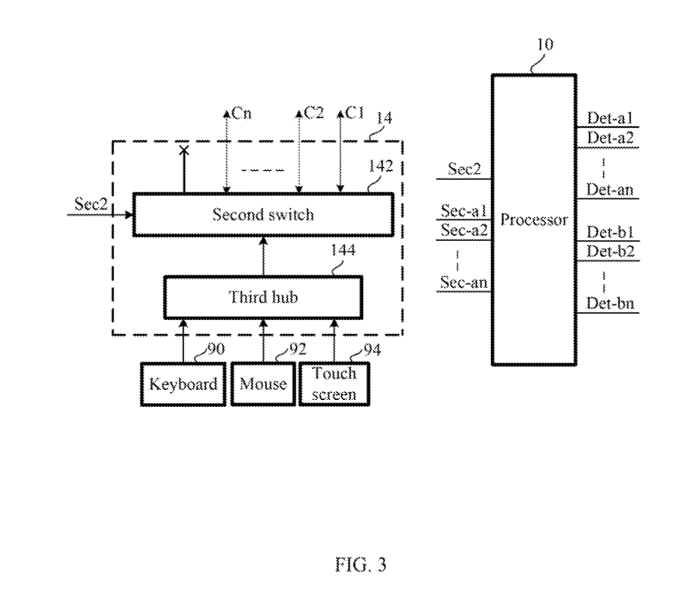

FIG. 3 illustrates that the processor 10 can include a plurality of first pins Det_a1-Det_an, a plurality of second pins Sec_a1-Sec_an, and a third pin Sec2. The first pins Det_a1-Det electrically connect to the first hubs D1-Dn in a one-to-one relationship. The second pins Sec_a1-Sec_an electrically connect to the first switches E1-En in a one-to-one relationship. The third pin Sec2 is electronically connected to the second switch 14.

The second switch module 14 can include a second switch 142 and a third hub 144. The second switch 142 includes a second switching terminal and a plurality of third fixed terminals, and a fourth fixed terminal. The second switching terminal is electronically connected to the third hub 144. The third fixed terminals electrically connect to the connected terminals C1-Cn in a one-to-one relationship. The second switching terminal is capable of electronically connecting to the third fixed terminals for turning on the second switch 142, or is capable of electronically connecting to the fourth terminal for turning off the second switch 142.

The third hub 144 can include a third input terminal and three third output terminals. The third input terminal of the third hub 144 is electrically connected to the second switching terminal of the second switch 142. The three third output terminals electronically connect to the keyboard 90, the mouse 92, and the touch screen 94 respectively. As a result of lifting one of the user loads A1-An, under either the first working mode or the second working mode, the second switch 142 establishes a electrical connection between the third input terminal of the third hub 144 and the second output terminal of a specified first hub corresponding to the selected user load. Thus, the keyboard 90, the mouse 92, and the touch screen 94 are electronically connected with the selected user load.

In at least one embodiment, under the first working mode, by lifting one of the user loads A1-An and one of the internal components B1-Bn, a specified first switch connected to a specified second hub corresponding to the selected internal component controls a specified first hub corresponding to the selected user load to electrically connect with the specified second hub. Thus, the selected user load and the selected internal component are electrically connected. Under the second working mode, by lifting one of the user loads A1-An, the first switches E1-En establish electrical connections between the second output terminals of the second hubs F1-Fn and a specified first hub corresponding to the selected user load. Thus, the selected user load is simultaneously connected to all of the internal components B1-Bn.

For example, under the first working mode, the user load A1 and the internal component B1 are selected, the first switch E1 establishes the connection between the first hub D1 and the second hub F1. Thus, the user load A1 and the internal component B1 are electrically connected. Further, when the read/write operation between the user load A1 and the internal component B1 is occurring, the first hub D1 generates the first locking signal and the second hub generates the second locking signal. The processor 10 controls the first switch E1 to be locked for keeping the connection between the first hub D1 and the second hub F1 in response to the first locking signal and the second locking signal. When the read/write operation between the user load A1 and the internal component B1 is finished, the first hub D1 generates the first unlocking signal and the second hub generates the second unlocking signal. The processor 10 controls the first switch E1 to cut off the connection between the first hub D1 and the second hub F1 in response to the first unlocking signal and the second unlocking signal.

In use, the internal components A1-An, of the electronic device 100 simultaneously connect with a selected user load for communication. Thus, communication convenience between internal components and the selected user load increases.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An electronic device connected with a plurality of load medias, the electronic device comprising:
a plurality of internal components;
a processor configured to generate different control signals; and
a first switch module connected to the internal components, the load medias, and the processor;
wherein the processor is capable of switching between a first working mode and a second working mode;
in the first working mode, when a first load media and one of the internal components are selected, the processor generates a first control signal, and the first switch module establishes an electronic connection between the first load media and the selected internal component, in response to receiving the first control signal generated by the processor;
in the second working mode, when a second the load media is selected, the processor generates a second control signal, and the first switch mode establishes electronic connections between the second load media and all of the remaining internal components, thereby enabling the second load media to communicate with all of the remaining internal components.

2. The electronic device of claim 1, wherein the first switch module further generates a first locking signal and a second locking signal while a read/write operation occurs between the first and second load medias and the connected internal component(s), the processor controls the first switch to be in a lock state for preventing the read/write operation from being interrupted in response to the first locking signal and the second locking signal.

3. The electronic device of claim 2, wherein the first switch module further generates a first unlocking signal and a second locking signal while the read/write operation is finished, the processor controls the first switch to be cut off in response to the first unlocking signal and the second unlocking signal.

4. The electronic device of claim 1, wherein the first switch module comprises a plurality of first hubs, a plurality of first switches, and a plurality of second hubs; each of the first hubs comprises a first input terminal and a plurality of first output terminals; each of the first switches comprises a first switching terminal and a plurality of first fixed terminals; each of the second hubs comprises a second input terminal and a plurality of second output terminals; each of the first hubs simultaneously connects with the first switches through the first output terminals; each of the first switches simultaneously connects with the first hubs D1-Dn through the first fixed terminals; the second input terminals electrically connect to the internal components in a one-to-one relationship.

5. The electronic device of claim 4, wherein the first switching terminal is capable of electrically connecting to one of the corresponding first fixed terminals for turning on the corresponding first switch.

6. The electronic device of claim 4, wherein each of the first switches further comprises a second fixed terminal; each of the first switching terminals is capable of electronically connecting to the corresponding second fixed terminal for turning off the corresponding first switch.

7. The electronic device of claim 4, wherein under the first working mode, the first switch connected between the first hub corresponding to the first load and the second hub corresponding to the selected internal component turns on; under the second working mode, all of the first switches turns on for establishing connections between the first hub and all the second hubs, thus the second load media simultaneously connects with all of the internal components.

8. The electronic device of claim 3, further comprising a second switch module, a keyboard, a mouse, and a touch screen; wherein each of the first hubs further comprises a plurality of connected terminals; each of the first switches further comprises a second fixed terminal; the second switch module comprises a second switch and a third hub; the second switch comprises a second switching terminal and a plurality of third fixed terminals; the third hub comprises a third input terminal and three third output terminals; the second switching terminal is electronically connected to the third hub; the third fixed terminals electrically connect to the connected terminals in a one-to-one relationship; the three third output terminals electronically connected to the keyboard, the mouse, and the touch screen respectively.

9. The electronic device of claim 8, wherein under either the first working mode or the second working mode, based on the first or second load medias, the second switch establishes a electronically connection between the third input terminal and the second output terminal of the first hub corresponding to the first or second load medias, thus the keyboard, the mouse, and the touch screen are electronically connected with the first or second load medias.

10. The electronic device of claim 8, wherein the second switch further comprises a fourth fixed terminal; the second switching terminal is capable of electrically connecting to the fourth fixed terminal for turning on the second switch.

11. A switch apparatus in an electronic device with a plurality of internal components; the switch apparatus connected between the internal components and a plurality of loads besides the electronic device; the switch apparatus configured for switching between a first working mode and a second working mode; the switch apparatus comprising:
a first switch module connected between to the internal components and the loads;
where under the second working mode, the first switch mode establishes electronically connections between the specified load and all of the internal components, thus the selected load simultaneously connect with all of the internal components for communicating.

12. The switch apparatus of claim 11, where under the first working mode, the first switch module establishes an electronically connection between a specified load and a specified internal component for communicating.

13. The switch apparatus of claim 11, further comprising a processor; wherein the first switch module further generates a first locking signal and a second locking signal while a read/write operation occurs between the selected load and the connected internal component(s), the processor controls the first switch to be in a lock state for preventing the read/write operation from being interrupted in response to the first locking signal and the second locking signal.

14. The switch apparatus of claim 13, wherein the first switch module further generates a first unlocking signal and a second locking signal while the read/write operation is finished, the processor controls the first switch to be cut off in response to the first unlocking signal and the second unlocking signal.

15. The switch apparatus of claim 11, wherein the first switch module comprises a plurality of first hubs, a plurality of first switches, and a plurality of second hubs; each of the first hubs comprises a first input terminal and a plurality of first output terminals; each of the first switches comprises a first switching terminal and a plurality of first fixed terminals; each of the second hubs comprises a second input terminal and a plurality of second output terminals; each of the first hubs simultaneously connects with the first switches through the first output terminals; each of the first switches simultaneously connects with the first hubs D1-Dn through the first fixed terminals; the second input terminals electrically connect to the internal components in a one-to-one relationship.

16. The switch apparatus of claim 15, wherein the first switching terminal is capable of electrically connecting to one of the corresponding first fixed terminals for turning on the corresponding first switch.

17. The switch apparatus of claim 15, wherein each of the first switches further comprises a second fixed terminal; each of the first switching terminals is capable of electronically connecting to the corresponding second fixed terminal for turning off the corresponding first switch.

18. The switch apparatus of claim 15, further comprising a second switch module, a keyboard, a mouse, and a touch screen; wherein each of the first hubs further comprises a plurality of connected terminals; each of the first switches further comprises a second fixed terminal; the second switch module comprises a second switch and a third hub; the second switch comprises a second switching terminal and a plurality of third fixed terminals; the third hub comprises a third input terminal and three third output terminals; the second switching terminal is electronically connected to the third hub; the third fixed terminals electrically connect to the connected terminals in a one-to-one relationship; the three third output terminals electronically connected to the keyboard, the mouse, and the touch screen respectively.

19. The switch apparatus of claim 18, wherein under either the first working mode or the second working mode, based on the selected load, the second switch establishes a electronically connection between the third input terminal and the second output terminal of the first hub corresponding to the selected load, thus the keyboard, the mouse, and the touch screen are electronically connected with the selected load.

20. The switch apparatus of claim 19, wherein the second switch further comprises a fourth fixed terminal; the second switching terminal is capable of electrically connecting to the fourth fixed terminal for turning on the second switch.
